(19) United States
(12) Patent Application Publication
(10) Pub. No.: US 2009/0228396 A1
(43) Pub. Date: Sep. 10, 2009

(54) CONTENT DISTRIBUTION OF STORAGE MEDIA FOR SALE, RENTAL AND RESALE

(76) Inventor: Bruce D. Miller, North Reading, MA (US)

Correspondence Address: ROBERT SCHULER, 45 GROTON ROAD, SHIRLEY, MA, 01464, US

(21) Appl. No.: 12/466,830

(22) Filed: May 15, 2009

Related U.S. Application Data
(63) Continuation of application No. 11/681,374, filed on Mar. 2, 2007, now abandoned.

(51) Int. Cl. H04L 9/00; G06Q 30/00; G06Q 50/00

(52) U.S. Cl. 705/59; 705/1

(57) ABSTRACT

In one embodiment, content is delivered to a customer over a communications network and written to a storage medium. The customer may be authorized to make additional copies of the content. The delivered content and copies are tracked in support of rental, sale or resale applications.

### REFERENCE TO RELATED APPLICATION

This application is a continuation of and claims the benefit of the filing date of U.S. application Ser. No. 11/681,374.

### BACKGROUND

There are several contemporary models for the sale and distribution of digital content. The prevailing model is based upon authoring content on “read only media” and distributing the media to customers via wholesale and retail channels. FIG. 1 shows pictorially how this model works. The media (in this case, a DVD-ROM) is produced by a studio or production company. Production includes the content formatting steps such as authoring and the physical production of the disc, inserts and packaging. The finished product must be physically shipped using a distribution network 2 to wholesalers and retailers who will provide the end product for sale or rent to the consumer 3. In this illustrative case, the end product is a DVD movie that will be played on a DVD player 4 and viewed on a display device such as a television 5.

An emerging model for content distribution is shown in FIG. 2. In this model, content is distributed to a personal computer 10 or media device 11 using the internet and local data interconnect provided by the customer's data carrier 6. Within the customer premises, a cable modem, DSL modem, fiber-to-the-home optical network terminal (FTTH ONT) or satellite modem 7 serves as a carrier data termination device and passes packets to the customer's local data infrastructure. This can be implemented with wired connectivity using switches/routers 8 or wirelessly with 802.11b/g/n routers 9. In this model, the content provider streams data to the personal computer 10 and/or the media device 11. The content (a movie, for example) is either directly streamed for viewing on a monitor/television or locally stored for viewing at a subsequent time.

### SUMMARY

The present invention relates to enabling content to be recorded on media for sale or rental, for that content to be uniquely tracked and for the content to be reclaimed as part of a rental model or in support of a return for credit sale/resale model.

Accordingly, a method comprises acquiring an identifier that is associated with a particular copy of content and with a virtual license for managing access to the content and writing the identifier and content to a storage medium.

A method comprises reading an identifier from a storage medium, the identifier associated with a virtual license for managing access to content stored on the storage medium; sending the identifier for validation; and reclaiming content stored on the storage medium upon validation of the identifier.

A method comprises reading a first identifier from a first storage medium, the first identifier associated with a virtual license for managing access to content stored on the first storage medium; sending the first identifier for validation; writing the content and a second identifier to a second storage medium upon validation of the first identifier.

A method comprises delivering a copy of content to a customer over a communication network and associating the delivery with the customer in a customer virtual license. In an embodiment, the copy of the content is reclaimed and the reclamation is associated with the customer in the customer virtual license.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views.

The drawings are not necessarily to scale, emphasis instead being placed upon illustrating embodiments of the present invention.

FIG. 1 illustrates a mechanism for content authoring and distribution on DVD-ROM;

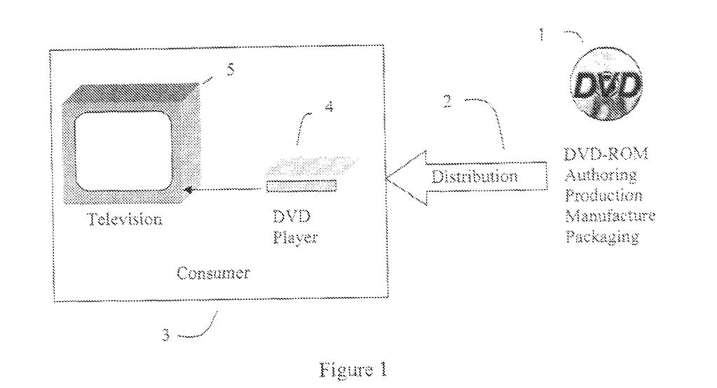

FIG. 2 illustrates a mechanism for content distribution to a PC or media device for viewing at the premises;

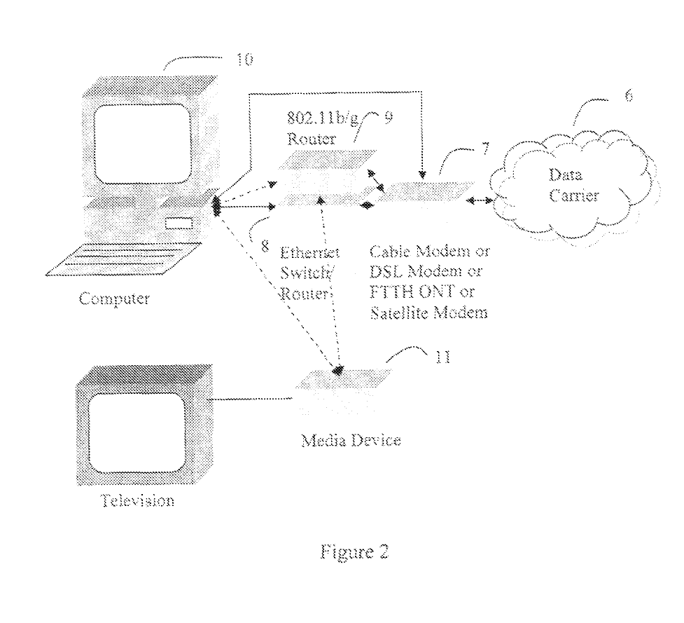

FIG. 3 illustrates an example mechanism for distributing content via a data network and locally burning a DVD-R;

FIG. 4 illustrates an example mechanism for requesting content and creating a virtual license and Unique ID;

FIG. 5 illustrates an example mechanism for transferring content and writing the media;

FIG. 6 illustrates an example mechanism for returning content and reclamation;

FIG. 7 illustrates an example mechanism for creating licensed copies of content;

FIG. 8 illustrates an example mechanism for surrendering multiple copies of content;

FIG. 9 illustrates an example of a Unique ID for DVD-R (DVD-ROM 20 managed recording);

FIG. 10 illustrates the format for the control area within the lead-in of a DVD;

FIG. 11 illustrates the format for a data sector of a DVD;

FIG. 12 illustrates the format of a virtual license;

FIG. 13 illustrates a block diagram of an example embodiment of a customer personal computer or commercial kiosk;

FIG. 14 illustrates an example back office infrastructure for a content provider;

FIG. 15 illustrates an example mechanism for requesting content and creating a virtual license without a Unique ID;

FIG. 16 illustrates an example mechanism for creating licensed copies of content without a Unique ID; and

FIG. 17 illustrates an example mechanism for surrendering multiple copies of content without a Unique ID.

### DETAILED DESCRIPTION

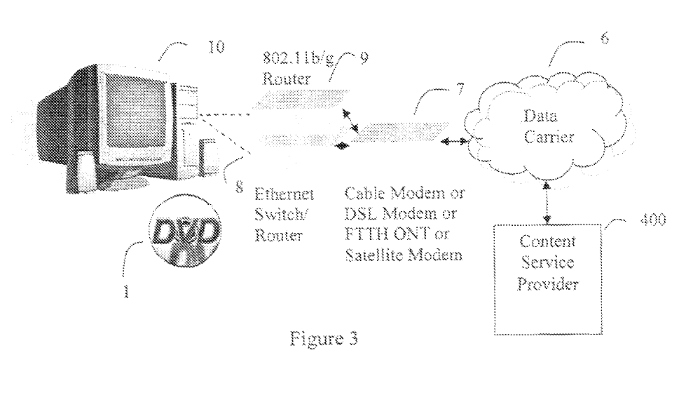

A high level view of an infrastructure that supports sale, rental and resale model using a recordable media is shown in FIG. 3. Digital content is transmitted from a content provider 400 through data infrastructure elements 7, 8, 9 via data carrier 6. The content is stored on the customer's personal computer 10. In this case, the content is written to media 1 for use in standard DVD players in a DVD-ROM compatible format. The appeal of this model is that the content is no longer tied to the infrastructure and can be easily moved between physical devices and premises.

Most studios mandate that their content be protected using an encryption scheme to prevent unauthorized duplication. The standard encryption technique for DVD-ROM is CSS (content scramble system). CSS scrambles occasional sectors containing multimedia data in such a way that the data cannot be used to recreate a valid signal. Scrambled sectors are encrypted with a combination of a title key and disc key. The title key is stored in the sector header; this is normally not readable from a DVD-ROM drive or other DVD reader. The disc key is hidden in the control area of the disc, which is also not directly accessible. In order to prevent duplication, writable DVD formats (DVD-R, DVD-RW) typically prevent writing to the control portion of the recordable disc. As such, a DVD-ROM disc can not be duplicated on DVD writable media.

The DVD Forum has recently ratified an amendment to this approach to allow so-called “managed recording”. With managed recording, DVD-R and DVD-R/W media are allowed to support writing to the control area of the disc so as to produce DVD-ROM compatible discs that can be read with the existing DVD player infrastructure.

Embodiments of the invention enable an infrastructure that provides a rental and secondary market for digital content. In an embodiment, a “virtual license” is associated with a physical copy (e.g., a movie on DVD) and a virtual licensee. Based upon this association, content can be recorded, tracked, copied and subsequently relinquished as part of a rental or resale model.

Typically a digital watermark is used to provide a hidden mechanism for validating that content is authentic and not a duplication. There are a number of techniques that are used to hide digital watermarks to make them difficult to decode and reproduce. In the present approach, a digital watermark or Unique ID associated with a copy of digital content functions in part as a transaction receipt. The Unique ID does not have to be hidden as it defines the rights that the customer enjoys relative to renting or purchasing the digital content. The actual validation may be done by the content provider or an intermediary.

In embodiments of the invention, Unique IDs and virtual licenses are created as the foundation of a rental and resale model that is unique. One application example of this approach is to deliver recorded media to a customer (at home or at a public kiosk) as part of a rental model. The customer can play the content recorded on the media during the tenure of the rental and then relinquish the content as part of a “return” process.

Another application example is a model where content can be sold and subsequently resold on a virtual secondary market. In this model, the virtual license may be transferred from one holder to another and the physical copy reclaimed from one licensee and recorded on new media for another licensee.

Another application is to provide a derivative form of the content for a second media. An example of this is a rental of a movie with rights to view it on a mobile device. Another application is to support the sale of content and allow either physical or virtual backup copies for personal use as allowed by regional law. Another application is to support the creation of physical copies or a virtual copy (i.e., the ability to get a copy of purchased content)

The principles described herein are widely applicable to a variety of digital content that is rented or sold including, but not limited to, movies, videos, songs, digital games and copyright art. In addition, it is applicable to a wide variety of electronic data storage media including, but not limited to, disc storage devices such as DVD, Blu-ray, HD-DVD, CD-R, and flash memory devices such as XD Picture Card, SD Memory and USB flash drives. Throughout the specification the terms “medium” and “media” are used interchangeably.

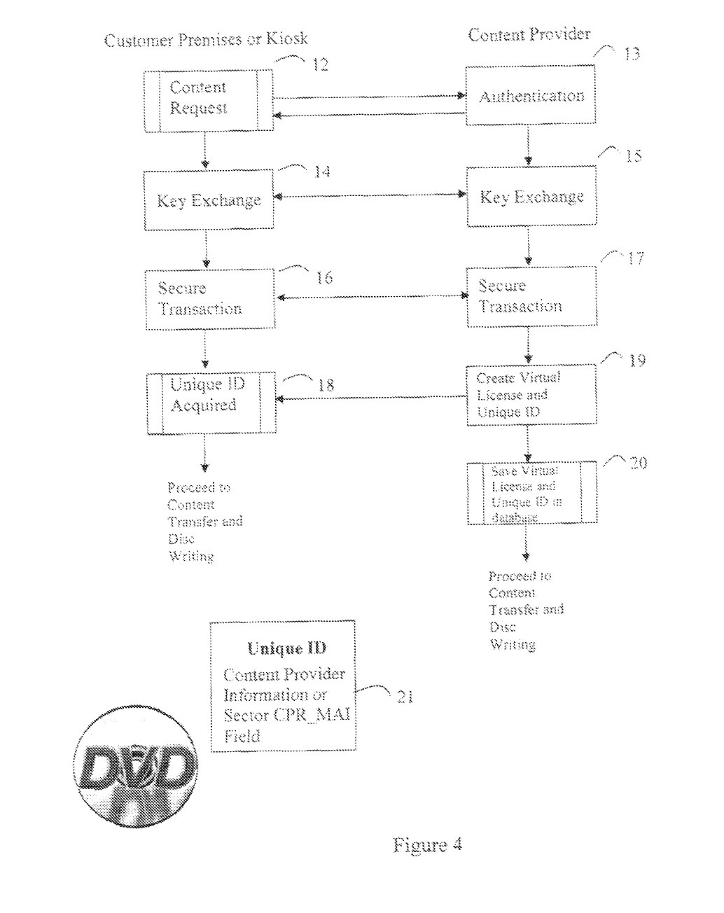

FIG. 4 illustrates an example process for requesting content and acquiring a “Unique ID” and “virtual license” between a content provider and a personal computer located at a customer premises or a customer service kiosk. The Unique ID is a unique code that identifies the unique recorded instance of the content on a particular media. The virtual license is a structure in a database in the content provider's back office that designates that instance of content has been written to a media and the correlation to the Unique ID. It should be noted that with the present approach, multiple copies of content may be recorded on different media based upon the limits of the rights given by the content provider or intermediate provider. The Unique ID allows the content provider to track the content distribution and support reclamation.

In FIG. 4, content is requested 12 by a customer. The content may be a movie, a game, music or any other licensed and writable content. The content provider may authenticate 13 the customer to insure that this is a trusted requestor. Once the authentication process is complete, a key exchange process occurs 14, 15, based upon a set of public keys to provide the customer/kiosk and the content provider with a set of private keys to use for the balance of the transaction(s). A person skilled in the art will be aware of protocols appropriate for authentication and key exchange. A transaction occurs 16, 17 to authorize the use of the requested content. The transaction may require another set of keys to be exchanged based upon the specifics of the implementation. The transaction is completed in a secure fashion. The transaction may typically involve the downloading of digital content to be temporarily stored on the customer's computer and subsequently transferred to recordable media.

The content provider creates 19 a virtual license and Unique ID, both of which are stored 20 by the content provider and provide a mechanism for identifying the licensed copies of the content that have been distributed. The Unique ID is created and sent to the customer/kiosk 18 to be used during the process of writing the media. In this particular example, a DVD-R disc will be written using DVD-ROM formatting as per the DVD Forum managed recording initiative. In the example of a DVD, the Unique ID can be written in one of two locations 21. The lead in area of the DVD provides a Content Provider Information area of 28,672 bytes that are arranged as 192 copies of an ECC Block containing 16 sectors. The data portion of the sectors is open to the use and format as determined by the content provider. A second option is to use a portion of the CPR MAI field located in the sector headings. Both approaches are examined in more detail further herein.

It should be noted that in writing to electronic storage devices it is often important to protect the content and not leave it in the clear and susceptible to unauthorized copying. Many devices support encryption algorithms for this purpose. The SD Card (Secure Digital Card) uses CPRM to provide digital rights protection. Memory Stick supports a Sony algorithm called Magic Gate. As such these media are reasonable candidates for storing content with digital rights management.

The DVD-R (managed recording) will allow the control area of the disc to be written. The control area of the disc provides space for recording manufacturing identification and content provider information (and the disc key). Either of these regions may be used to write the Unique ID although the more conventional approach would be to use the content provider area. In addition, the Unique ID may be encrypted to prevent access in the clear. Since in the case of DVD the media can be scratched, the Unique ID may be written multiple times to maximize the likelihood of a readable instance of the Unique ID should the disc be damaged.

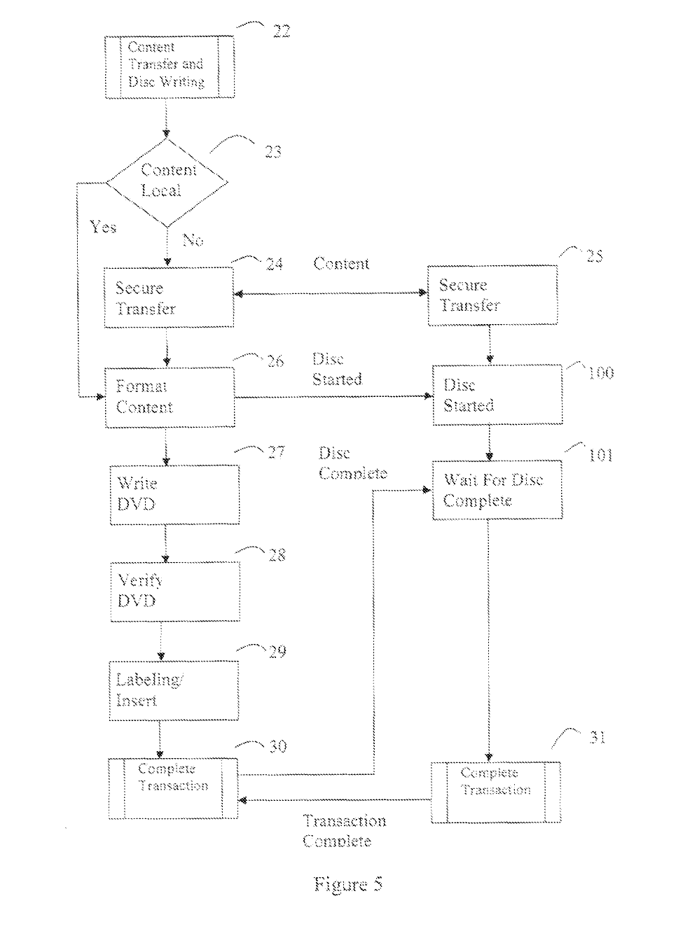

FIG. 5 is the continuation of the process initiated in FIG. 4 and illustrates the process for transferring content and writing the media (in this case a DVD). The process is entered at 22 once the transaction is authorized as in the process of FIG. 4. If the content is available locally (such as in the high run content at a kiosk), then the transfer of content to the customer/kiosk is not necessary and the process can proceed, skipping that step. In many cases, the content will need to be transferred. If the content is not local 23, then a secure transfer is initiated 24, 25. The secure transfer allows the content to be retrieved from a server and locally stored for writing to a storage media. A separate key exchange may be required for this transfer. A person skilled in the art will be familiar with key exchange as a matter of standard practice. Once the content is transferred, it may need to be formatted for the target media 26. The most efficient compression technique currently is MPEG 4; however, the standard for DVD-ROM is MPEG2. As such, the content may have to be trans-coded from MPEG4 to MPEG2 prior to being written to the disc. The content provider may be signaled that the content is being processed and written to the disc. Note that the content may be stored temporarily on the customer's personal computer to minimize the delay time associated with downloading content such as for a rental queue. A disc started notification received from the customer PC or kiosk causes the content provider/intermediary to move from waiting for the disc to be started 100 to waiting for the disc to be completed 101. Meanwhile the content and Unique ID are written to the media 27 by the customer PC/kiosk based upon the appropriate formatting for that media. A location and example format of the Unique ID is described further herein.

DVD ROM is formatted using industry standard sectors and with standard headers. This format is well known. Once the media has been written, it is verified 28. There are a number of techniques to do this and many media include cyclic redundancy checks (CRC) and error correction codes (ECC/parity) that can be used to easily verify the integrity of the written content. Once the media has been written, it can be labeled 29. For a DVD, there are multiple ways to do this. It is possible to use a printer to write the top surface of a printable disc. Alternatively, technology exists for direct writing to the DVD top surface (HP Lightscribe™) using a laser operating at higher power than used for normal disc data recording. This requires the customer to turn over the disc and use the compliant burner for this operation. Alternatively, a simple adhesive label can be prepared and attached to the disc.

At this point in the process, the content has been written to the disc, verified and labeled. In a kiosk application, the media is dispensed; in a customer premises application, the customer may be notified that the disc is complete and available for use. The application running on the customer personal computer or at the kiosk notifies the content provider/intermediary that the media is complete and the content provider/intermediary locally completes the transaction 31 and notifies the customer or kiosk that the transaction is complete 30. At this point, the content has been written to 10 the media (with or without a Unique ID) and the content provider has created a virtual license (including the Unique ID, if that has been created).

While the foregoing describes writing content to storage media at a customer personal computer or customer service public kiosk, in other embodiments the storage media may be written at a production facility, distribution point or retail facility.

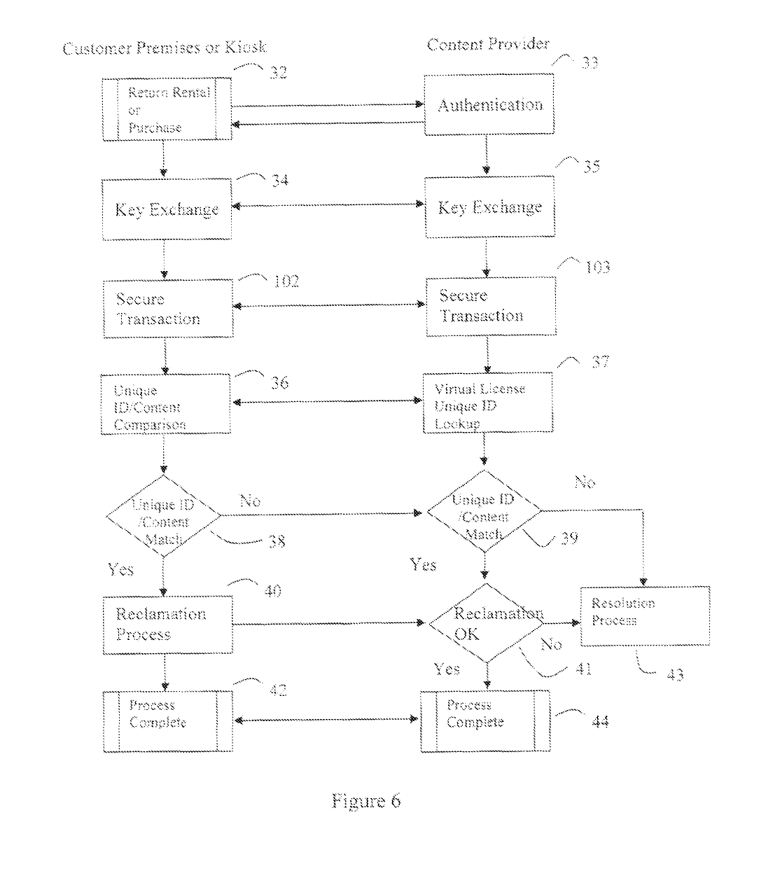

FIG. 6 illustrates an example process for returning the content as part of a rental model or reclamation for credit model. The process is initiated by the customer either using their personal computer or at a kiosk 32. An authentication 33 is done to verify that this is a trusted requester. A key exchange 34, 35 is done using public keys to provide private keys to use during the secure transaction. A secure transaction 102,103 is initiated to relinquish the content. In a rental model, the customer may be relinquishing the content to get new content (movie, game, music). Alternatively, the customer may relinquish the content for credit or monetary transfer as part of a sale/resale model.

The Unique ID which may be encrypted is read from the media. The Unique ID is sent to the content provider along with (optionally) some descriptive information about the content/licensee 36, 37 and used for lookup of the virtual license. In an embodiment, a customer ID may be used to simplify the virtual license lookup. The customer may use the customer ID and a password as part of the secure transaction 102, 103 and this also can be used to find the customer's virtual licenses. The Unique ID must match the information in the virtual license and correspond to a valid virtual license 38, 39. If this process produces an error such as the inability to read the Unique ID, does not correlate with the Content ID, or the disc proves to be damaged, then a resolution process is invoked 43. The nature of the resolution process is up to the content provider/intermediary and may include such actions as suspension of the customer's virtual license or account, contact of the customer by a customer services representative or other actions.

The reclamation process 40 involves reclaiming the content stored on the media or physically reclaiming the media. In the case of a DVD-R, the DVD-R may be overwritten rendering the media unreadable or unusable for playback. There are a number of mechanisms to do this. One mechanism is to overwrite a portion of each sector to prevent the reading of the AV content. As described further herein, a reclamation bit may be defined in the Unique ID that allows a compliant DVD reader/writer to determine that this DVD has been reclaimed and is not just damaged. In addition, the disc can be visually marked using technology such as Lightscribe™ to indicate that the disc is no longer usable (an X across the top of the disc, for example).

The reclamation process can also be a physical event. For a kiosk application, the disc may be physically captured and placed into a storage bin. It is also possible to physically destroy the disc by shredding or other destructive means. Once the reclamation process completes, the virtual license is appropriately updated by the content provider and proper credit is given. When all the copies under a virtual license are returned, the virtual license can be marked as inactive. In addition, the content provider/intermediary can mark a virtual license inactive as part of the resolution process or for other reasons. For a rental model, it is typical to allow a limited number of different games or movies to be rented by a customer at any time. So, the reclamation process is the mechanism for the customer to get new rental content. For the sale of digital content, the reclamation is part of a crediting process that either gives the customer monetary credit, merchandise credit or consideration for the return of the content. This model may be an alternative to selling the physical media on a secondary market such as eBay and allow the content provider/intermediary the ability to collect transfer fees in lieu of the selling fees incurred by others to physically sell the media. In the event that the reclamation process does not properly proceed to completion 41, then the content provider/intermediary invokes the resolution process 43. The process is completed 42, 44 based upon successful reclamation (or resolution).

In some cases, it might be desirable to allow a customer to create a copy of the purchased content. This model allows the customer to either generate a copy of the content for their personal use (as allowed by the content provider) or generate a new master in the event that the original master is damaged. In some embodiments, the copy master generation and copy creation may occur within different infrastructures. A customer may acquire a master copy of content at a retail point and make copies using his/her personal computer or at a kiosk. The invention contemplates portability across these differing infrastructures.

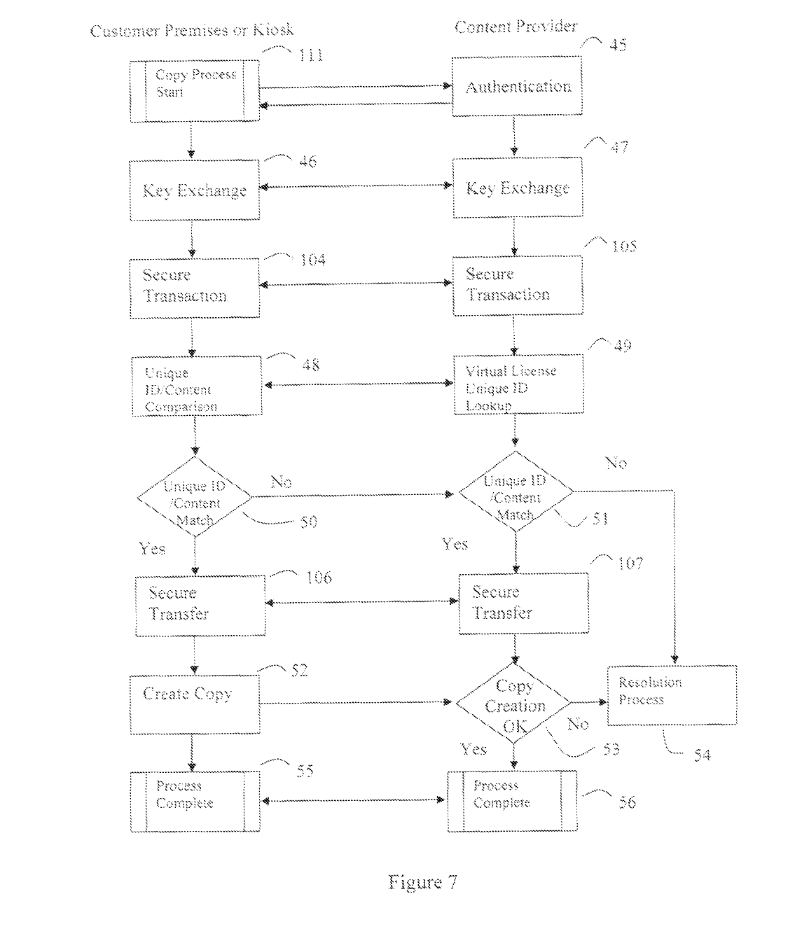

FIG. 7 shows an example process for generating an authorized copy. Note that the processes of FIG. 4 and FIG. 5 can be easily changed to produce a master and a number of copies. Such modifications will be clear to a person skilled in the art.

The process to create an authorized copy starts 111 when a copy of licensed content is requested. The content provider or intermediary authenticates 45 the user to verify that this is a trusted requestor. Public keys are used to support private key exchange for the subsequent transaction 46, 47. A secure transaction occurs indicating that a copy is being requested 104, 105. The licensed copy of the media (example DVD) may be read to verify the Unique ID 48 and content information. The content provider/intermediary may allow a copy of content to be made based upon only the submission of the customer ID and password. In the preferred model, the virtual ID is validated against the virtual license 49 to verify that a valid master or copy of the content matches the license information 50, 51. If the comparison does not match, then a resolution process 54 is invoked. The resolution process may involve requiring the customer to input their identification and password, email, secret (or other information) and reclaiming the master. The content provider or intermediary may require a valid master in order to allow production of a new copy or replacement master.

Once the licensed master is verified, it can be removed from the system and a copy or replacement master can be made 52. The copy process may include copying the content from the master disc into an intermediate buffer or it may require a new internet download 106, 107.

The copy or replacement master is written with a Unique ID that is different from the master in order to allow it to be identified and uniquely tracked. In the event of a replacement master, the original master may be reclaimed. If the copy is not correctly created 53, then the resolution process is invoked 54. In addition, it should be noted that the copy may require a secure transfer, such as in the event of the replacement of a damaged disc. That is shown in the process flow in 106, 107 Once the copy has been made, verified and finalized, it is registered with the content provider or intermediary 56 and the transaction is completed 55, 56.

The virtual license indicates the number of copies (if any) that are permitted and contains a format for holding copies of the Unique IDs of the master and any outstanding copies of the content as described further herein. It is possible that a copy may be written to a different media such as an iPod (H.264) and information about the media can be similarly maintained in the virtual license.

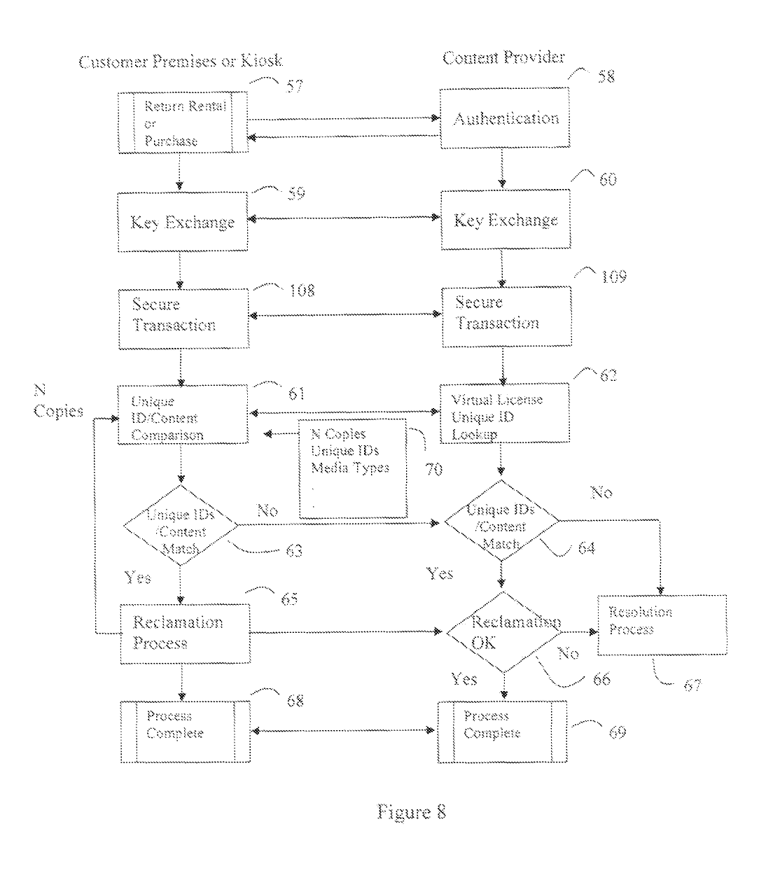

FIG. 8 shows a modified reclamation process to support reclamation of multiple copies of content on various media. The process is started 57 by a request for reclamation as part of a sale, rental or resale model. Authentication occurs 58 and then the key exchange 59, 60. A secure transaction allows the application running on the customer's personal computer or at the kiosk and the content provider/intermediary to agree on the reclamation transaction 108, 109. The Unique ID is acquired from the media 61 and the content provider or intermediary validates the Unique ID 62. The content provider or intermediary indicates to the application running on the customer's personal computer or at the kiosk how many copies of the content are currently outstanding 70, whether this is the master and what type of media the content is stored on. From there the reclamation process is an iterative cycle of validating the multiple copies of the recorded content and reclaiming it 61, 63, 65. The resolution process 64, 67 determines how to handle the transaction in the event of a problem.

Upon normal completion of the reclamation of the master and the copies, the application running on the customer's personal computer or kiosk signals to the content provider's back office 65 and the content provider will validate that it processes concur that the reclamation has completed properly 66. Based upon this agreement, the transaction can be completed between the content provider 69 and the customer 68.

While the foregoing describes reclaiming content from storage media at a customer personal computer or customer service public kiosk, in other embodiments the storage media may be reclaimed at a production facility, distribution point or retail facility.

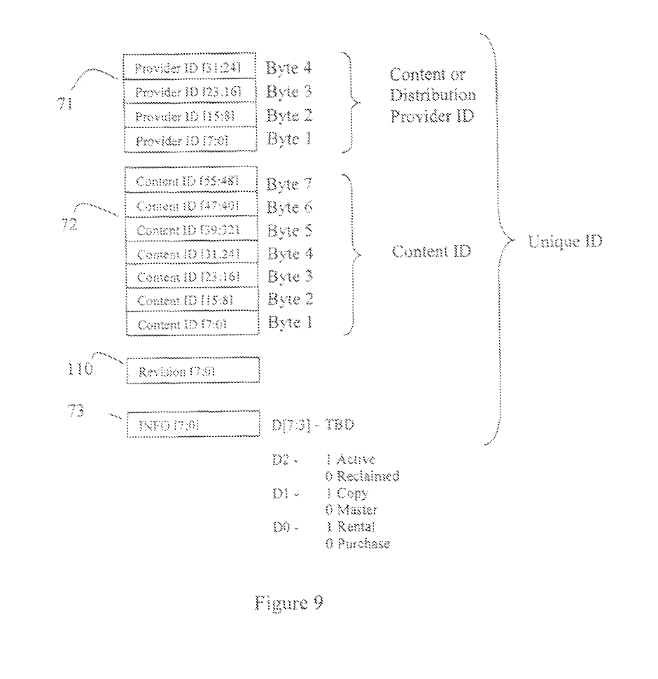

FIG. 9 shows an example format for the Unique ID for use with a DVD-ROM 15 formatted disc using a DVD-R physical media. The Content ID 72 is shown as a 7 byte field capable of supporting 72 quadrillion content IDs. The Content ID is a field that uniquely identifies every unique instance of content. The Provider ID 71 field is a field to uniquely identify a content provider or intermediary. The Provider ID 71 allows different providers to assign Unique IDs without coordination provided the Provider ID 71 is unique defined amongst the content providers. The 5 byte field is capable of delineating over 4 billion unique content providers. The Revision field 110 allows several revisions and potential interpretations of the Unique ID. The Info field 73 provides basic information regarding the disc. Bit DO can be used to determine whether a disc is a rental or purchased version. Note that in DVD-R a 1 is the unwritten state of a bit, so a rental version may be changed to a purchased version by changing this bit from a 1 to a 0. Bit D1 indicates whether this is a content master or a content copy. Once programmed as a copy, the bit can not be changed to a master designation. Bit D2 indicates whether the media is active or reclaimed. This bit is intended to provide a mechanism for a compliant reader/writer to determine that the content has been reclaimed. A noncompliant reader/writer will simply not be able to play the content after reclamation as the disc is essentially corrupted by the reclamation process. The media is physically reclaimed (e.g., physical return of the media, shredding) or the content overwritten to prevent playing in a standard player as previously described. If a Lightscribe™ or equivalent burner is used, then the top of the disc can be marked during the reclamation process to indicate that it is reclaimed. The example Unique ID format is 13 bytes.

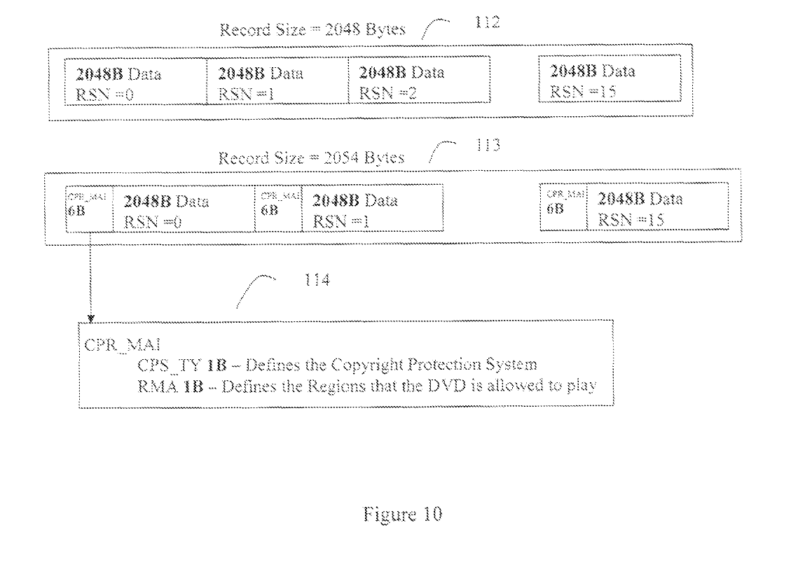

FIG. 10 shows the standard formats of the Content Provider Portion of the Lead In Area of a disc formatted using the DVD-ROM format. There are two possible formats based upon a 2048 byte record 112 and a 2054 byte record 113. In either case, there are a total of 16 sectors that are repeated within the content provider area 192 times. The 2054 byte format 113 adds a 6 byte CPR_MAI 114 field to the 2048 byte data field. The CPRMAI 114 field provides the CPS_TY byte that defines the copyright protection system and the RMA 1 byte field that defines the permissive geographic region(s) authorized to play the disc. The data portion of the Content Provider Information field is not defined by standard and is open to specific provider use. The Unique ID can be easily added when the disc is written. It is possible to encrypt the Unique ID and/or use a cryptographic cipher to scramble the bits among the sectors and fields, as is subsequently described.

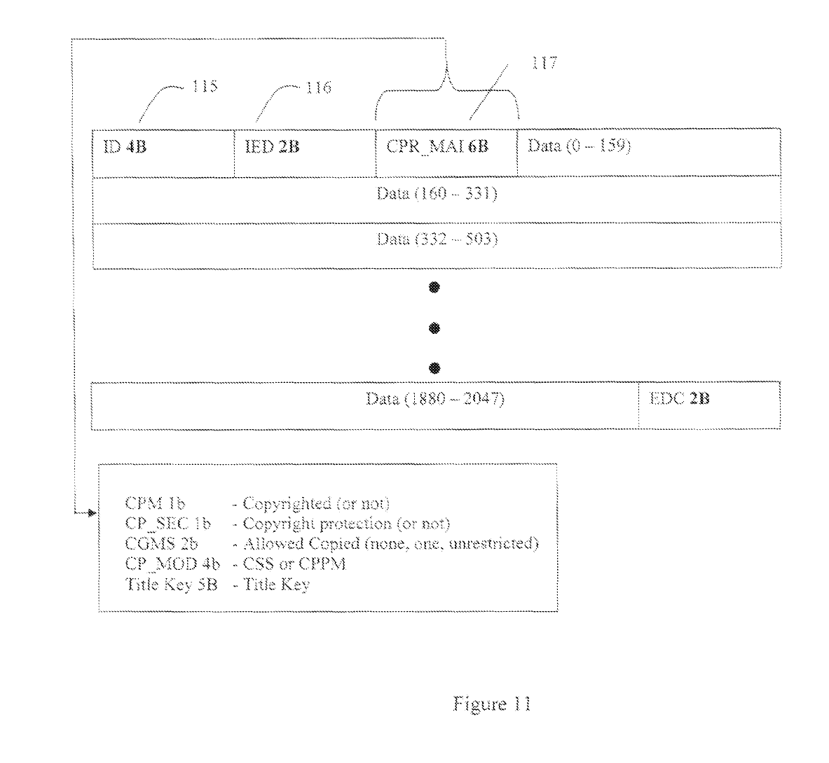

Another option is shown in FIG. 11 which shows the standard format of a data sector for DVD-ROM. The header is comprised of the ID field 115, the IED field 116 and the CPR MAI field 117. The ID field 115 contains information about the physical attributes of the disc and the sector number. It is protected by an ID Error Detection field 116. The CPR MAI field 117 stores the 5 byte title key and a one byte header. Within the header is the CP MOD field. The CP MOD field is intended to delineate the encryption mechanism (DVD_ROM format) and uses a single bit to indicate CSS or CPPM. The second bit is used for DVD-R/DVD-R/W to indicate the format. The upper two bits are reserved. As such, these bits are available and may be used to encode the Unique ID in the header of the DVD data sector. The Unique ID can be stored across multiple headers in an open fashion or using a cryptographic cipher.

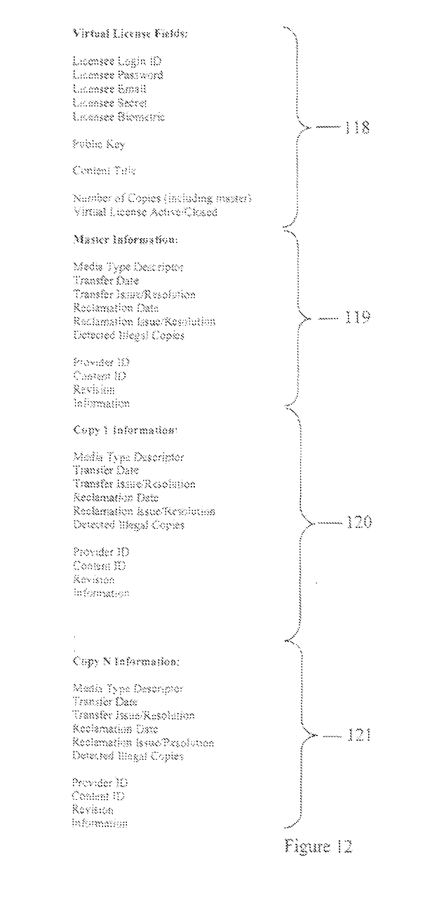

FIG. 12 illustrates an example format for the virtual license stored by the content provider or intermediate provider. The virtual license is a data construct that exists on a server and is used to track and manage the licensed or rented content. The general record 118 contains information about the licensee (or renter), public keys, the content title, the number of copies outstanding and whether the license is active or closed. The master record 119 is the descriptor for the content master that is being licensed (or rented). There is a media type descriptor, a transfer date and information about transfer issue resolution (if applicable). In addition there is information about reclamation and the ability to designate the detection of inappropriate use of the content (unauthorized copies). A copy of the Unique ID is also part of this record. The copy records 120, 121 are the same format as the master record; there is a copy record for every permitted copy of the content.

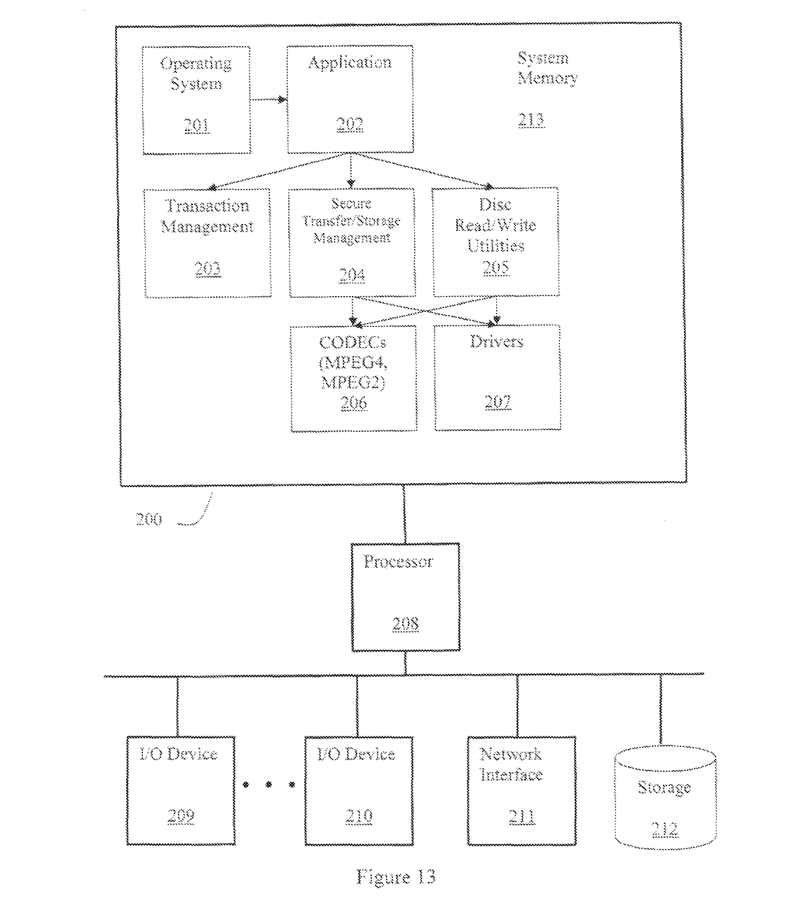

FIG. 13 shows a block diagram of a customer personal computer or customer kiosk or distribution/retail computer 200. The personal computer includes a memory subsystem 213 that uses conventional random access memory (RAM) 213 and storage subsystem 212. The RAM 213 provides volatile storage for code and data during execution. The storage subsystem is the bulk storage and primary nonvolatile store for the PC 200. The PC utilizes a standard processor or processor cluster 208, I/O devices 209, 210 and a network interface 211. The processor 208 is responsible for executing instructions and manipulating data under the direction of the operating system. The processor runs the applications, utilities and drivers associated with principles of the present invention and other standard operation of the personal computer. The I/O devices 209, 210 include conventional devices such as keyboard, mouse, display devices, and the like. The network interface 211 is a conventional network interface that is configured to interface the PC 200 with the network 6. To that end, the network interface 211 comprises the conventional interface circuitry that incorporates signal, electrical characteristics and interchange circuits needed to interface with the physical media of the network and the protocols running over that media. For example the network interface 211 may include satellite, telephone lines, internet links, wireless or other suitable communication channels. The storage subsystem 212 is a conventional storage medium configured to hold a structured query language (SQL) database and other data structures and programs.

The memory 213 and storage subsystem 212 stores an operating system 201, application(s) 202, transaction management utilities 203, secure transfer/storage utilities 204, disc write/read utilities 205, CODECs 206, and drivers 207. The operating system 201 is a conventional operating system (such as Microsoft Vista or Linux) configured to schedule the execution of processes and applications including the application 202 that is responsible for managing the transaction and content, including the execution of the localized portion of the process flows shown in FIGS. 4, 5, 6, 7, 8, 15, 16, 17. The application 202 includes the graphical user interface (GUI) and is responsible for the overall interaction and control flow at the customer premises, retail location or kiosk. The transaction management utility 203 is responsible for the transaction between the customer and the content provider/intermediary infrastructure including establishing a secure session and initiating, managing and closing transactions. The secure transfer/storage management utility 204 manages the transfer and storage of content. It is responsible for getting content from the provider, decrypting, trans-coding and locally storing that content. In addition, it is responsible for providing the content to the utilities to create a disc and for the reclamation process associated with surrendering the content on the disc. The utilities utilize a number of coder/decoders (codecs) 206 to manage the compression and encryption algorithms. The system includes drivers 207 responsible for the management of the low level operations of the various devices (e.g., I/O devices 209, 210 and network interface 211). The I/O devices 209, 210 also may include DVD or other devices for writing content to storage media. In a customer service kiosk the I/O devices 209, 210 may include reclamation devices such as a shredding device or other like devices.

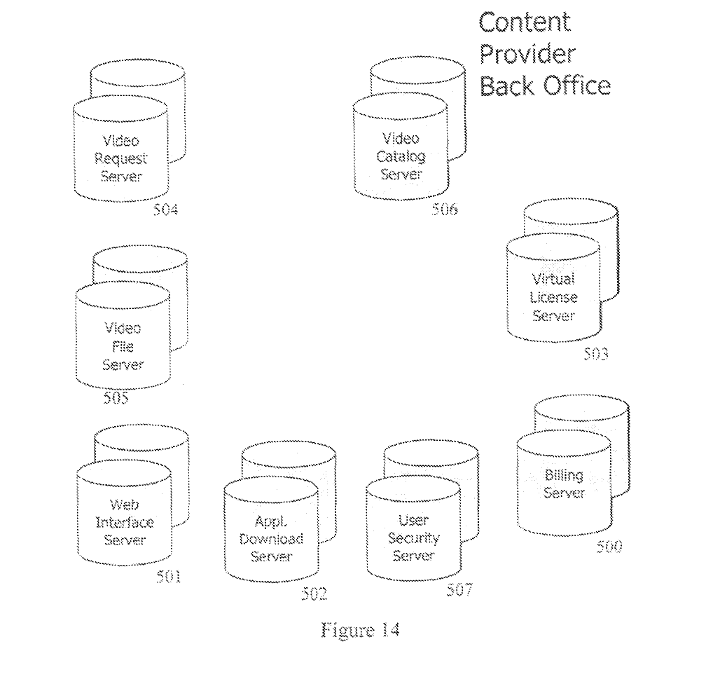

FIG. 14 is a block diagram of an example embodiment of the content provider back office. The content provider may establish several regional offices to support regional distribution of content. Some of the servers and communication may remain intra-office; however, the servers can be located across multiple offices. The back office is comprised of a number of specialized services with communication protocols that allow an overall service to be offered to a customer including rental, sale resale and/or distribution of content services.

In an example flow, a customer performs a number of operations to be considered a customer of the services of this infrastructure. Initially, the customer sets up a billing account so that the billing server 500 has the necessary information to bill for services. In addition, the customer may download an application to run on the customer personal computer and implement the previously described processes. The download is effected through communication with the web server interface 501 and the application download server 502.

The application running on the personal computer allows the customer to create a queue of movies, games or music to rent and/or buy. The content provider transfers some of the movies, games or music to the customer's computer to facilitate faster access. The remaining movies in the queue simply comprise the access sequence for the customer. The customer may be allowed to have between 1 and N movies/games/music on recorded media at any point in time, as is the current model for contemporary rental companies. In addition, the customer can choose to purchase content by downloading it or converting rented content to purchased content. The customer can return content for credit as part of a rental or secondary sales model.

Consider the server and customer interaction required specifically to support renting a movie. The customer typically pays a set monthly fee that entitles the customer to hold a fixed number of movies at any time. Once the local application has been installed on the customer's personal computer and that computer has been verified to be eligible for the service (e.g., supports the correct DVD burner) then the customer can create a sequential queue of movies for rental. The customer is free to modify the queue by adding, deleting or changing the order of the movies. A movie at the head of the queue will be requested for rental (presuming that the customer is eligible based upon not already having the maximum number of rentals outstanding). The browser on the customer's personal computer contacts the web interface server 501. The web interface server communicates with the billing server 500 and the virtual license server 503 to verify that this is a customer in good standing. At this point, the web interface server turns over control to the video request server 504. The video request server 504 authenticates the customer via personal computer and establishes a secure session for communication (via the exchange of private keys). This is done in coordination with the user security server 507. The video request server 504 asks the video catalog server 506 to direct it to the video file server 505 that holds the content for distribution. The video catalog server 506 has a catalog of the content available for distribution and maintains a view of video file server 505 loading. As such, it can provide load balancing for content download. The video file server establishes a secure session with the customer's personal computer to protect the content during the download process. The content download involves sending large compressed/encrypted files to the customer's personal computer. There is requisite control to insure that the transfer completes properly or can recover from a disruptive event.

Once the content (in this case a movie) has been downloaded, it is available for transfer to the recordable media (DVD-R). The application on the personal computer directs the customer to insert a blank media and instruct the customer through the sequence of producing a copy of the media. This includes burning the content and optionally flipping the DVD-R to allow the top side to be written with a picture or title. The video request server 504 provides the personal computer with the keys to decrypt the movie and make the compressed content available for burning. In addition, the disc key and title key are transferred in order to allow the content to be encrypted with CSS.

The local application on the personal computer may decrypt and transcode the movie. The video request server 504 communicates with the virtual license server 503 to create a virtual license and Unique ID and communicate the Unique ID to the application running on the customer's personal computer. The Unique ID is written to the disc as described above.

The local application validates the integrity of the written copy and based upon a valid burn, contacts the video request server to notify it of a completed validated master/copy of content. The video request server 504 notifies the virtual license server 503 that the content burn is complete and a valid copy of the content is in the possession of the customer. The video request server 504 sends the application on the personal computer a message indicating that the content is complete and the application notifies the customer that the transaction is completed. The communication session can now be completed.

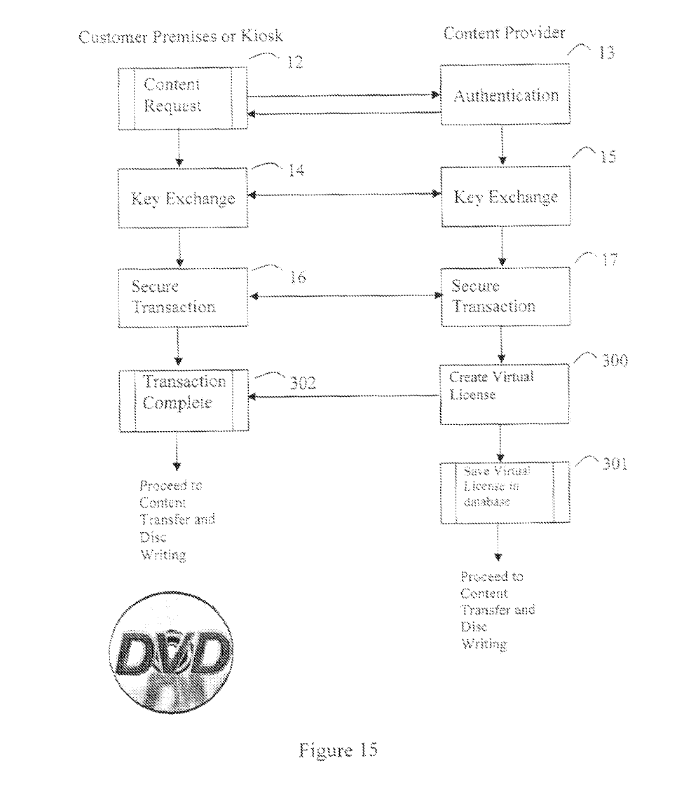

FIGS. 15, 16, and 17 show an alternate embodiment of the invention. In this implementation, a Unique ID is not generated or written to the media. This is a less secure implementation and the validation of the transaction may be made based upon the validation of the licensee and verification of the content. As such, verification is based upon the licensee's id, password, and secret. The Unique ID is not used, and the content is verified by title or an alternate means. The process shown in FIG. 15 is a derivative of the process shown in FIG. 4; this is the process flow for a secure transaction. Steps 12 through 17 remain identical. In step 300 a virtual license is created. The content provider/intermediary signals to the customer's personal computer or kiosk that the transaction is complete and does not send a Unique ID 302. The content provider/intermediary saves the virtual license without the Unique ID fields 301. FIG. 5 remains the same for this implementation except that the Unique ID is not written to the disc during the execution of the process flow. As such, FIGS. 15 and 5 show an alternate process flow for creating a secure instance of content on a disc without a Unique ID.

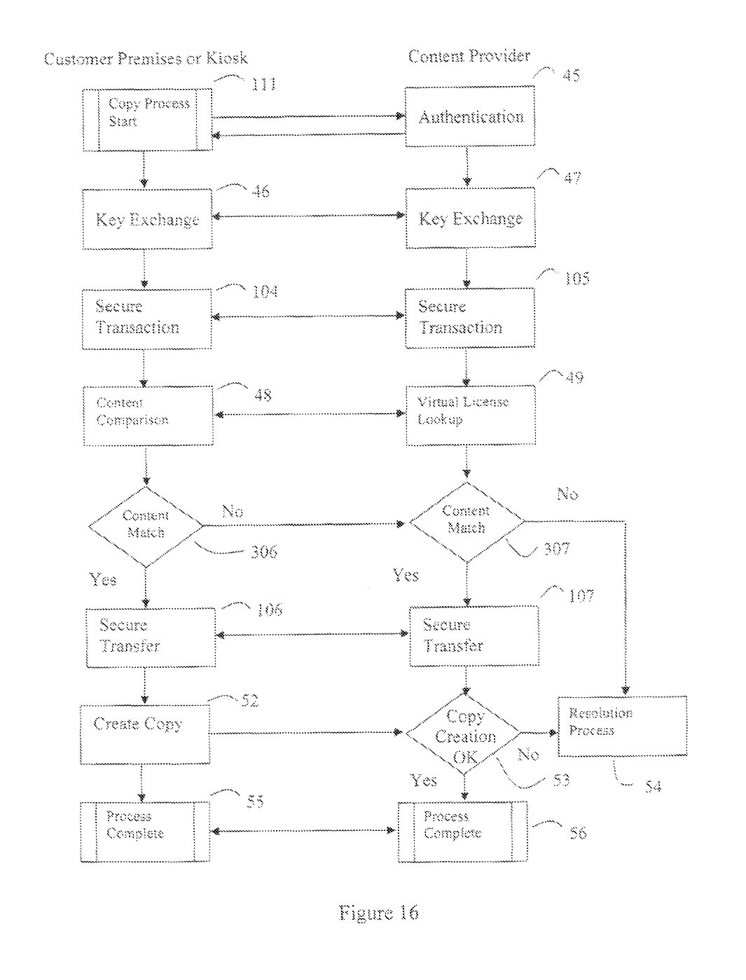

The copy process shown in FIG. 16 is similar to the copy process shown in FIG. 7 except that there is no Unique ID comparison at steps 48, 49.

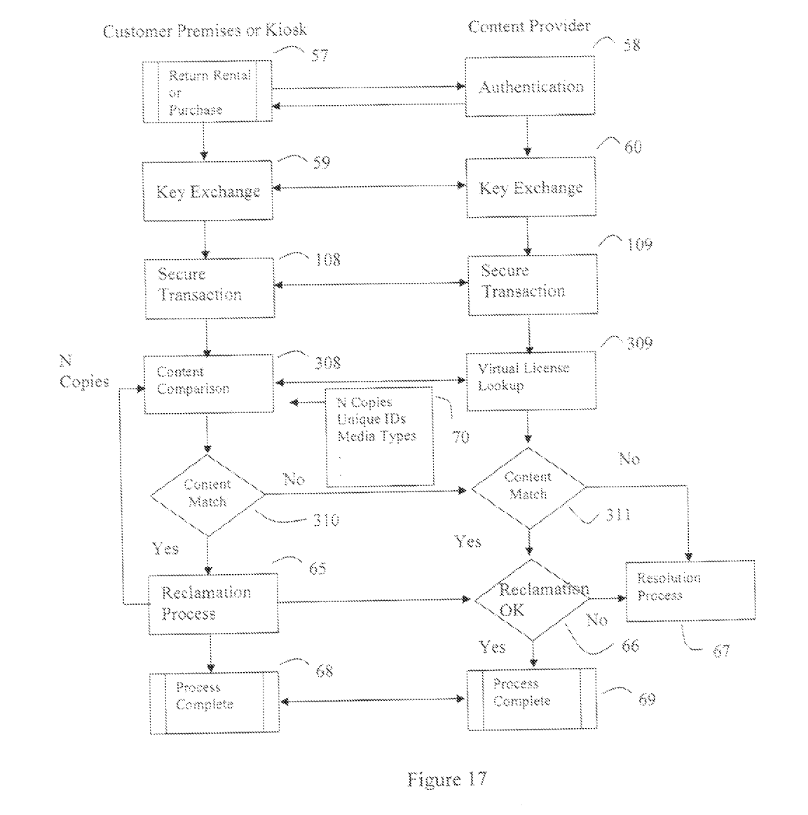

The process shown in FIG. 17 is a derivative of the process shown in FIG. 6. This is the process flow for reclaiming a copy of the content. All steps are identical to the steps shown in FIG. 6 with the exception of 308, 309, 310, and 311. In these steps the content is verified by the title or an alternate means instead of the Unique ID. Again, the overall security of the transaction is based upon verification of the licensee and is not as strong at the preferred implementation.

While this invention has been particularly shown and described with references to example embodiments thereof, it will be understood by those skilled in the art that various changes in form and details may be made therein without departing from the scope of the invention encompassed by the appended claims.

I claim:

1. A method of managing access to content over a communications network, comprising:
a customer and a content provider entering into a virtual licensing agreement for access to licensed content;
the customer sending a request including first unique content identification information to the content provider to make at least one copy of the licensed content;
the content provider receiving the request and using the first unique content identification information to validate the request against the virtual licensing agreement;
the content provider sending a message including second unique content identification information to the customer authorizing copying of the licensed content;
the customer receiving the message including the second unique content identification information authorizing copying of the licensed content; and
the customer writing the content and the second unique content identification information to a storage medium.

2. The method of claim 1 wherein the storage medium is one of a disk storage device and a flash memory device.

3. The method of claim 1 wherein the content is one of video, audio game software program and a still image.

4. The method of claim 1 wherein the first and second unique content identification information is comprised of content provider distribution information and content identification information.

5. The method of claim 1 wherein the first and second unique content identification information is encrypted.

6. The method of claim 1 wherein the content is written to the storage in one of a public kiosk, a customer personal computer, a production facility, a distribution point and a retail facility.

7. The method of claim 1 wherein the virtual license is a database structure indicating that an instance of content is written to the storage medium and correlating the content with the second unique content identification information.

8. The method of claim 1 further comprising;
the customer sending the second unique content identification information to the content provider for validation; and
the content provider reclaiming the content written to the storage medium upon validation of the second unique content identification information.

9. The method of claim 8 wherein validation of the second unique content identification information includes comparing the second unique content identification information to information contained in the virtual license.

10. The method of claim 1 further comprising;
the customer sending the second unique content identification information to the content provider for validation;
the content provider validating the second unique content identification information and sending a third unique content identification information to the customer; and
the customer writing the content and the third unique content identification information to another storage medium.

11. The method of claim 10 wherein validation of the second unique content identification information includes comparing the unique content identification information to information contained in the virtual license.

12. A method of managing access to content over a communications network, comprising:
a content provider entering into a virtual licensing agreement with a customer over the communications network for access to licensed content;
the content provider receiving a request from the customer over the communications network, including first unique content identification information, to make at least one copy of the licensed content; and
the content provider sending a message over the communications network, including second unique content identification information, to the customer authorizing copying of the licensed content.

13. The method of claim 12 wherein the content is one of video, audio game software program and a still image.

14. The method of claim 12 wherein the first and second unique content identification information is comprised of content provider distribution information and content identification information.

15. The method of claim 12 wherein the first and second unique content identification information is encrypted.

16. The method of claim 12 further comprising:
the customer receiving the message, including the second unique content identification information, over the communications network authorizing copying of the licensed content; and
the customer writing the content and the second unique content identification information to a storage medium.

17. The method of claim 12 further comprising:
the content provider receiving the second unique content identification information over the communications network from the customer for validation; and
the content provider reclaiming the content copied to the storage medium over the communications network upon validation of the second unique content identification information.

18. The method of claim 17 wherein validation of the second unique content identification information includes comparing the second unique content identification information to information contained in the virtual license.

19. The method of claim 12 further comprising:
the content provider receiving the second unique content identification information over the communications network from the customer for validation;
the content provider validating the second unique content identification information and sending a third unique content identification information to the customer over the communications network; and
the customer writing the content and the third unique content identification information to another storage medium.

20. Apparatus for managing content, the apparatus comprising:
a network interface for receiving unique content identification information that is associated with a particular copy of content and with a virtual license for managing access to the content; and
a processor configured to copy the unique content identification information and content to a storage medium.

21. The apparatus of claim 20 wherein the network interface receives the content and the unique content identification information over a communications network from a content provider.

22. The apparatus of claim 20 wherein the storage medium is a disk storage device or a flash memory device.

23. The apparatus of claim 20 wherein the content is selected from any of video, audio, game software program and still image.

24. The apparatus of claim 20 wherein the unique content identification information includes content provider distribution information and content identification information.
